(19) United States
(12) Patent Application Publication
(10) Pub. No.: US 2007/0185770 A1
(43) Pub. Date: Aug. 9, 2007

(54) ELECTRONIC ADVERTISING DISPLAY

(75) Inventor: Stephen Rubie, Elanora Heights (AU)

Correspondence Address: BARNES & THORNBURG LLP, P.O. BOX 2786, CHICAGO, IL, 60690-2786, US

(73) Assignee: Eye Corp Pty Ltd, Pyrmont (AU)

(21) Appl. No.: 11/559,803

(22) Filed: Nov. 14, 2006

Related U.S. Application Data
(60) Provisional application No. 60/736,884, filed on Nov. 14, 2005.

(51) Int. Cl. G06Q 30/00

(52) U.S. Cl. 705/14

(57) ABSTRACT

The invention of this application is a method and apparatus for remotely operated electronic advertising displays. The method and apparatus described herein allows for advertising images to be displayed on a plurality of advertising display units, the display units being accessible to a content distribution system through a wireless data network. The method includes transmitting data representing a new advertising image from the content distribution system to the plurality of advertising display units using a long range wireless data network, thereby making the data available to each advertising display unit for display thereupon.

### RELATED APPLICATION

The application claims priority to U.S. Provisional Application 60/736,884filed on Nov. 14, 2005.

### FIELD OF THE INVENTION

The present invention broadly relates to electronic advertising. In particular, the present invention broadly relates to remotely operated electronic advertising displays.

### BACKGROUND OF THE INVENTION

Malls, shopping centres, and other public spaces, such as airports, train stations, and the like provide opportunities to advertise products and services to shoppers and commuters.

A common technique for advertising in these spaces is to display posters advertising the products or services. These posters provide high resolution and high impact branding, often close to the point of sale. Such posters are typically displayed in display units which are bolted to the floor. If necessary, they can be unbolted and shifted to another position which provides a certain flexibility of positioning. The flexibility of positioning of these display units also provides advantages: for instance, they can be shifted to positions which will maximise their impact. Although the display units require access to sources of power, such access is generally readily available, particularly in malls and shopping centres. A further development has been to use display units which use a cartridge containing a series of different posters. The display unit scrolls through each poster in turn. The movement of the posters attracts the attention of potential targets and also enables a range of advertisements to be displayed from the same unit. This is useful because one of the difficulties with poster advertising in these public spaces is that the potential targets of the advertising are relatively mobile and there a number of distractions which divert their attention from the posters.

A difficulty with the more traditional display units is the need to replace the posters when new advertising material is required. This requires that an employee of the agency or company responsible for the units to physically remove the poster or cartridge containing the posters and replace it with a new poster or cartridge.

Advertising campaigns which use display units of this type usually cover a wide geographic area and it may be important to the campaign to have each display unit display the same poster. Clearly, when each poster has to be manually replaced, coordinating a new advertising campaign in which a large number of posters need to be changed is an enormous exercise.

### SUMMARY OF THE INVENTION

The present inventors have found that it is possible to use a long range wireless data network such as a publicly available mobile telephone (cell telephone) network to inexpensively transmit poster-quality images to a plurality of advertising display units located in malls, shopping centres and the like. As a consequence, the images displayed in advertising display units spread out over a wide geographic area can be changed practically simultaneously with minimal effort which is of enormous benefit to the implementation of new advertising campaigns. This can be achieved despite the typically low bandwidth and high bandwidth costs of such networks. The use of a mobile telephone network significantly reduces the cost of changing the image in a display unit vis-a-vis the alternatives and also alleviates the need to introduce additional infrastructure to support the network—a mobile telephone modem is the only communications infrastructure required. The display units are therefore as flexible in their positioning as the types of unit in which the posters need to be replaced physically.

The use of a long range wireless network avoids the need to use traditional means of networking which are expensive and often require significant infrastructure investments. For instance, to link the displays using a television network would require a television broadcasting system. Similarly, using a cabled Ethernet network would require each display unit to be physically connected to an Ethernet connection. In the public spaces where such display units are typically located, telephone lines and other internet connections are not readily available, particularly in the positions in which it would be most useful to display the units. Further, such an infrastructure requirement limits the flexibility of positioning of the units.

Accordingly, the present invention provides a method for causing a new advertising image to be displayed on a plurality of advertising display units, said plurality of advertising display units being accessible to a content distribution system through a long range wireless data network, said method comprising the steps of transmitting data representing said new advertising image from said content distribution system to said plurality of advertising display units using said long range wireless data network, whereby said data is made available to each of said plurality of advertising display units for display of the new advertising image; and subsequently displaying said new advertising image at said plurality of advertising display units; wherein said data is of sufficiently small size such that said data is received at each of said plurality of advertising display units shortly after transmission.

### BRIEF DESCRIPTION OF THE FIGURES

A preferred embodiment of the present invention will now be described, by way of example only, with reference to the accompanying figures, in which:

FIG. 1 is a schematic diagram showing one example of a display system for use in the method of the present invention;

FIG. 2 is a schematic diagram similar to that of FIG. 1;

FIG. 3 is a schematic diagram showing specific details of one example of part of a network which is shown in FIGS. 1 and 2;

FIG. 4 is a schematic diagram showing components of one example of an advertising display unit of the present invention;

FIGS. 5A, 5B and 5C are respective front, side and plan views of one example of an advertising display unit of the present invention;

FIG. 6 is a schematic perspective assembly drawing of the advertising display unit of FIGS. 5A, 5B and 5C;

FIGS. 7A, 7B and 7C are respective front, side and plan views of the advertising display unit of FIG. 6.

FIG. 8 is a sectional view of the advertising display unit of FIGS. 6 and 7 through A-A of FIG. 7A; and

FIGS. 9A and 9B are respective front and plan elevational views of the advertising display unit of FIGS. 5 and 6 showing in particular a ventilated housing of the display.

### DETAILED DESCRIPTION OF THE PREFERRED EMBODIMENT

The present invention provides a method for causing a new advertising image to be displayed on a plurality of advertising display units, said plurality of advertising display units being accessible to a content distribution system through a long range wireless data network, said method comprising the steps of transmitting data representing said new advertising image from said content distribution system to said plurality of advertising display units using said long range wireless data network, whereby said data is made available to each of said plurality of advertising display units for display of the new advertising image; and subsequently displaying said new advertising image at said plurality of advertising display units; wherein said data is of sufficiently small size such that said data is received at each of said plurality of advertising display units shortly after transmission.

Typically, the time taken for the data to be received is in the order of tens of seconds.

Preferably, each of said advertising display units is bolted or otherwise affixed to a floor or wall.

Preferably, each of said advertising display units comprises a display screen which is at least 75 cm across the diagonal.

Each of said plurality of advertising display units is preferably located in public spaces with ready access to power such as malls, shopping, centres, airports, train stations and the like. The method of the present invention allows for advertising campaigns to be implemented over a wide geographic area with minimal effort. Accordingly, said plurality of advertising display units is preferably distributed over a wide geographic area so that a proportion of said plurality of advertising display units is located in at least two separate public spaces.

As the data is received by each of said plurality of advertising display units shortly after transmission, a new advertising campaign can be implemented practically simultaneously over a wide geographic area using the method of the present invention.

The new advertising image is intended to be used as a substitute for conventional poster advertising and, more preferably, as a substitute for the scrolling advertising displays. Accordingly, there are certain preferred features required of the image in order for it to be of poster quality and size. The new advertising image is preferably high definition. “High definition” is a resolution defined by the MPEG 2 profile standard. The image preferably has a resolution of greater than or equal to 15 dots per centimetre. The image is preferably in a portrait format.

A street furniture poster has dimensions of 47 inches in width and 69 inches in height (82 inches across the diagonal). This corresponds to approximate dimensions of 1.2 m in width and 1.8 m in height. It is contemplated that the method of the present invention would use images having these dimensions, although the size of the images must be related to the size of the display screens and therefore images having other dimensions are also contemplated. For instance, a preferred format for the new advertising image is an aspect ratio of 16×9 at 75 cm measured along the diagonal and with a resolution of 1080×575 or greater. Other preferred formats include: 115 cm along the diagonal with a resolution of 1360×780; 143 cm along the diagonal with a resolution of 1920×1080; and 205 cm.

The image may be a still image or an animated image. It is contemplated that a number of separate new advertising images can be sent to each advertising display unit. In that case, it is preferred that each image is arranged to be displayed for a period ranging from 5 to 15 seconds.

The new advertising image is an image advertising information about a product or a service and may also include images relating to a point of sale display, a directory display or a vehicle departure or arrival display.

Preferably, the long range wireless data network is a publicly available mobile telephone network. Such networks provide advantages over the use of other types of network. They require little investment on the part of the advertising agency or client in the method of the present invention as they do not require the installation of infrastructure, are readily accessible, and are inexpensive to access and use. The technology and data rate of such networks are constantly being improved, and it is contemplated that any such network will be suitable. For instance, although the presently described embodiment uses a wireless General Packet Radio Service (GPRS) network, other mobile telephone networks such as 3G, Ev-Do and WiMax are also equally effective in the method of the present invention.

Despite their advantages, publicly available mobile telephone networks have inherent data rate limitations. For instance, conventional CDMA networks have a maximum data rate of between 144 kbps and 300 kbps, and more recent GSM and CDMA networks have maximum data rates of between 384 kps and 3.1 Mbps. Accordingly, the size of the files comprising the data which represents the new advertising image must be relatively small to allow the data to be received at each of said plurality of advertising display units shortly after transmission.

Use of relatively small file sizes provides difficulties in producing poster-quality images at the display units. However, the use of small file sizes not only allows for effective use of a publicly available mobile telephone network it also provides significant cost savings as the cost for use of networks is typically related to time of transmission and/or the amount of data transmitted.

Vector-based image formats generally use less data than other formats, such as raster-based formats, to represent the same image. Accordingly, it is preferred that the data representing the image is in a vector-based image format. Examples of software using vector-based image formats include Adobe Flash, Shockwave or QuickTime.

Preferably, the size of the file comprising the data is less than 5 MB, more preferably less than 2 MB, even more preferably less than 150 kB and yet more preferably less than 50 kB.

These file sizes have been found to be suitably small to allow the data to be received at each of said plurality of advertising display units shortly after transmission.

The advertising display units each comprise a display screen for displaying the new advertising image. Suitable screens include LCD screens, plasma screens, projection screens or LED screens although any suitable screen may be used. The display screen is preferably capable of displaying said new advertising image at a resolution of greater than or equal to 15 dots per cm which is required in order to display poster-quality images.

In a preferred form, the screen 120 has an aspect ratio of 16×9 and is a 75 cm screen (measured along a diagonal). The resolution of the screen is 1080×575 pixels (corresponds to a 16×9 aspect ratio). The screen could be larger or smaller in size than that described and could also have a greater resolution. For example, the screen could be a 100 cm screen having the same aspect ratio but a resolution of 1280×768 pixels; a 115 cm screen having a resolution of 1366×768 pixels; a 143 cm screen could having a resolution 1920×1080 pixels; or a 205 cm screen. For some applications the screen could have a resolution of 1920×1080 pixels. The screen could also have a different aspect ratio including one corresponding to a landscape format.

A street furniture poster has dimensions of 47 inches in width and 69 inches in height (82 inches across the diagonal). This corresponds to approximate dimensions of 1.2 m in width and 1.8 m in height. It is contemplated that the method of the present invention would also use screens having these dimensions.

The advertising display units each comprise a means for communicating with a long range wireless data network. In cases where the long range wireless data network is a publicly available mobile telephone network the means is a mobile telephone modem.

Each advertising display unit preferably comprises a means for storing the data representing the new advertising image which can be any suitable data storage mechanism such as a hard disk or flash memory.

The content distribution system is designed to receive data from an advertising agency or client, process that data as required and forward it, using the long range wireless data network, to the plurality of advertising display units. Accordingly, it will typically comprise a computer linked to the long range mobile network via a modem.

The invention will now be described by reference to preferred embodiments.

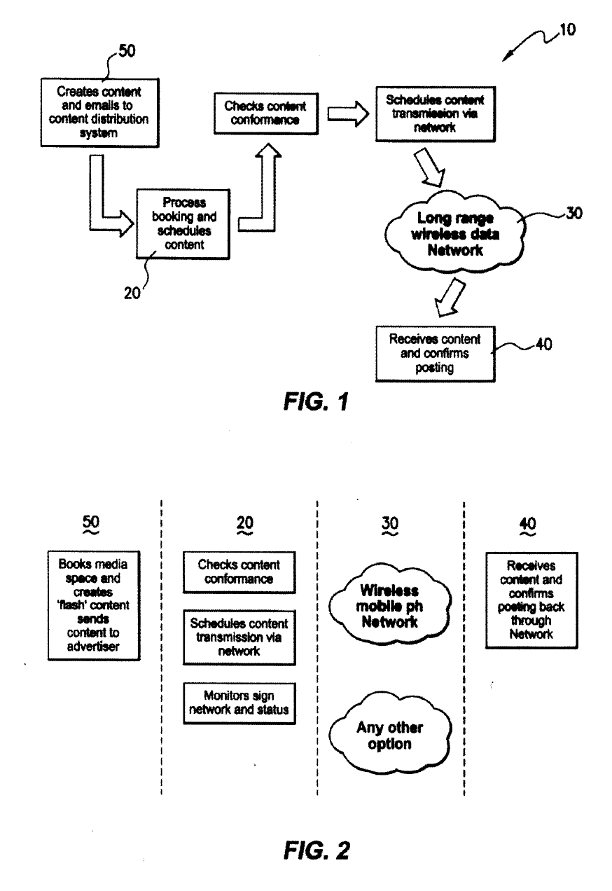

FIGS. 1 and 2 show an electronic advertising system to be used according to the method of the present invention 10. This particular example of an advertising system comprises a content distribution system 20, a long range wireless data network 30, and advertising display units 40. The content distribution system 20 provides data representing a new advertising image which is to be displayed by the plurality of advertising display units. In this particular example the step of providing data includes receiving data representing the image from an advertising agency or client 50.

Data received from the advertising agent or client 50 is preferably in a form which enables it to be directly transmitted to the plurality of advertising display units 40. However, for some applications the data will first be required to be converted or otherwise altered.

The content distribution system 20 generally comprises a display manager input, a display manager processor and a display manager output (all not shown). The content distribution system 20 is designed to receive data from the advertising agent or client 50, process that data as required, and forward it, or corresponding converted or otherwise altered data, to said plurality of advertising display units 40. The content distribution system 20 also includes data storage means, for example, a hard disk (not shown) for storing data.

Before transmitting electronic data to the advertising display units 40, the content distribution system 20 is designed to check that the data meets predetermined criteria. For example, part of the function of the content distribution system 20 includes checking that data received from the advertising agency or client 50 is provided as an appropriate file or in an appropriate format. In one particular application of the advertising display system 10, the content distribution system 20 checks that data received from the advertising agency or client 50 is a Macromedia Flash™ file. For other applications the display manager 20 checks that data received from the advertising agency or client 50 is either instead or alternatively a Shockwave™ or QuickTime™ file, or derived from Windows™ Media Player software or any other suitable software.

If the content distribution system 20 determines that the input data received from the advertising agency or client 50 does not conform with its predetermined criteria it requests additional or replacement data from the advertising agency or client 50. Alternatively, the content distribution system 20 converts or otherwise alters the input data to conform with the predetermined criteria.

The content distribution system 20 also communicates image, image scheduling, system status and system diagnostic information to or from the advertising display unit 40, and other parts of the advertising display system 10 including the network 30. Image scheduling details are defined by the content distribution system 20 as required by the advertising agency or client 50. The content distribution system 20 is, for example, able to switch the screen of each of the plurality of advertising display units 40 to standby mode when it is not required to display an image.

Scheduling information is transmitted to the advertising display units 40 and used by the advertising display units 40 to determine when images are displayed by them. Scheduling information can also be transmitted from the advertising display units 40 back to the display manager 20. Scheduling information returning from the advertising display units 40 can be used, for example to confirm that the advertising display units 40 have received the required scheduling information, or to monitor when images are actually displayed by the advertising display units 40.

As previously mentioned, the content distribution system 20 also communicates information concerning system status and diagnostics. The content distribution system 20 receives system status and system diagnostic signals from the advertising display units 40 and other parts of the content distribution system 20, and for example, the network 30. These signals may relate to any features of the advertising display units 40 or other parts of the system. The content distribution system 20 processes the system status and system diagnostic signals and passes on information as required to an operator of the content distribution system 20 via an output of the content distribution system 20.

For some applications the content distribution system 20 sends system status and system diagnostic signal requests to the advertising display units 40 and other parts of the advertising display system 10 requesting corresponding signals. The signal requests enable, for example, the advertising display units 40 or other parts of the advertising system 10 to be monitored. The signal requests can, for example, be designed so that the absence of a corresponding response signal is a negative response.

Status information may, for example, indicate whether the advertising display units 40 or the network 30 is operational. It may also, for example, indicate whether a door of an advertising display unit 40 is open, if the advertising display unit 40 is operating in an appropriate temperature range, or if external power is supplied to the advertising display unit 40. If the status is not as required an alarm is activated. The alarm can for example include an SMS message. However, the status information may also include more detailed information indicating, for example, images currently displayed by the advertising display unit 40 or the available capacity of the network 30. Status information may, for example, also provide actual, as opposed to scheduled, image display times. System status information may also indicate the status of various components of the advertising display units 40 which are described below. For example, it may indicate operation or malfunction of the components of the advertising display units 40.

System diagnostic information indicates, for example, faults with the advertising display units 40 or the network 30. More specifically, the system diagnostic information indicates the type of fault and the part of the advertising display unit 40 or network 30 that is responsible for the fault.

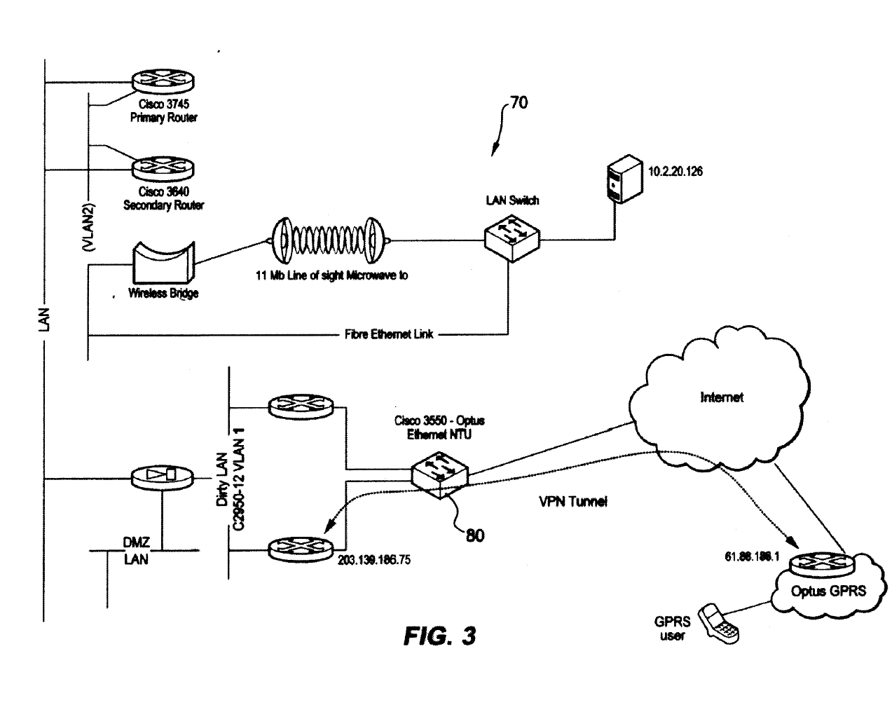

Referring to FIG. 3, the content distribution system 20 comprises a server (not shown) and local area network (LAN) 70. The LAN 70 communicates with the network 30 via a modem 80.

The network 30 is shown in FIGS. 1, 2, 3 and 4. In one preferred embodiment, the network 30 is a wireless General Packet Radio Service (GPRS) network. The content distribution system 20 is designed to transmit data over the network 30. This may include the scheduling of the transmission to use off-peak bandwidth. In other networks, the network 30 can comprise a wireless data networks which are suitable for networking the advertising display units 40 and the other components of the system 10. For example, it could alternatively comprise networks including 2G, 2.5G, 3G, GSM and CDMA networks.

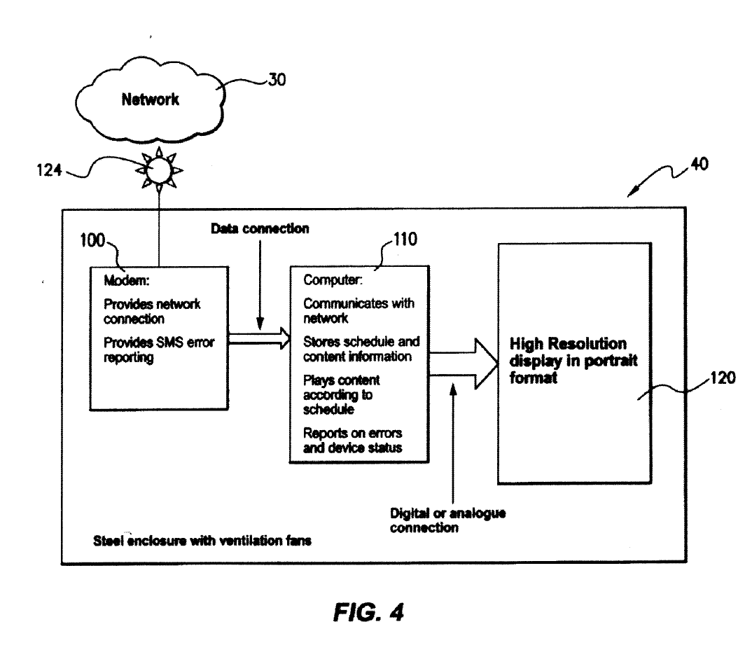

Referring to FIG. 4, the advertising display units 40 generally comprise network connecting means in the form of a modem 100, a processor 110 and display means in the form of LCD screen 120. The modem 100 has a speed ranging from about 64 to 200 kbps and includes an external aerial 124 for communication with the network 30. The advertising display units 40 also include image storage means in the form of a hard disk (not shown) for storing electronic data.

The hard disk stores information sent from the content distribution system 20. It also, if necessary, stores information which is required by the content distribution system 20 to be sent to the content distribution system 20.

The processor 110 processes information sent directly from the content distribution system 20, or via its associated hard disk, to fulfil the functions described above which the content distribution system 20 initiates. For example, the processor 110 processes information received from the content distribution system 20 which defines a vector based image to display a corresponding image on the LCD screen 120 as scheduled and sequenced by the content distribution system 20. The image is preferably represented by a Adobe Flash™ file.

For some applications the processor 110 displays a single image for a predetermined period of time on the LCD screen 120. For other applications the processor 110 displays 2 or more images on the LCD screen 120 in a particular manner. For example, 3 images may be alternately displayed on the LCD screen 120 for a predetermined period of time. Each of the images may, for example, be displayed for a period of time ranging from 5 to 15 seconds. Furthermore, each image may be a still image or a series of still images, an animated image, or a combination thereof. The file size of each image which may comprise a number of sub-images eg, a series of still images, is preferably less than or equal to about 2 Mb. For images that comprise a number of sub-images the file size of all of the sub-images is therefore less than or equal to about 2 Mb.

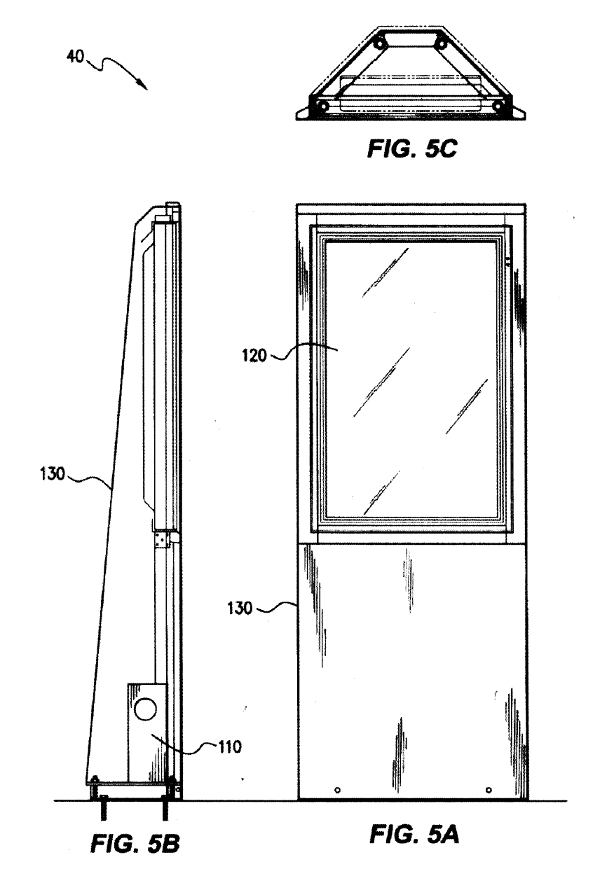

Referring to FIGS. 4 and 5A and 5B, the LCD screen 120 has an aspect ratio of 16×9 and is a 75 cm screen (measured along a diagonal). The resolution of the screen 120 is 1080×575 pixels (corresponds to a 16×9 aspect ratio). The LCD screen 120 could be larger or smaller in size than that described and could also have a greater resolution. For example, the LCD screen 120 could be a 100 cm screen having the same aspect ratio but a resolution of 1280×768 pixels, or a 115 cm screen having a resolution of 1366×768 pixels. For some applications the screen 120 could have a resolution of 1920×1080 pixels. The LCD screen 120 could also have a different aspect ratio including one corresponding to a landscape format.

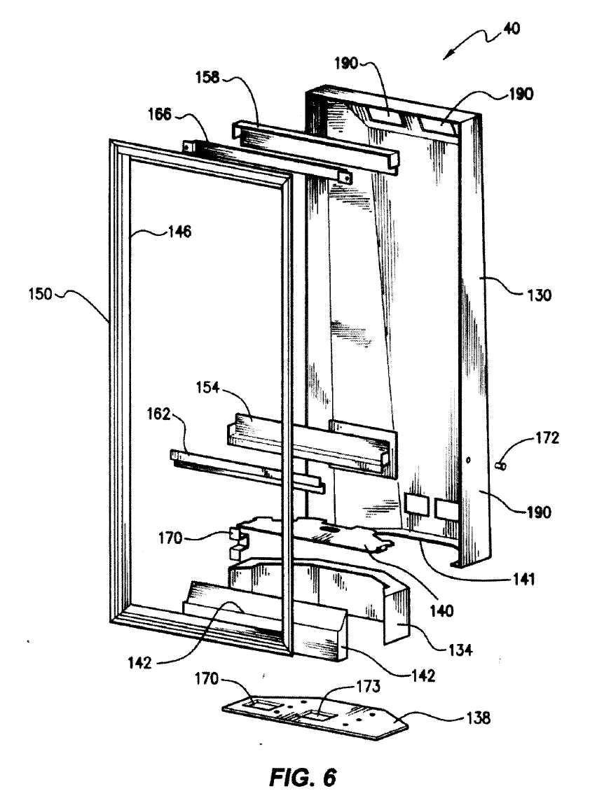

Referring to FIGS. 5-9, and in particular FIG. 6, the advertising display unit 40 generally comprises a main body 130, a base shroud 134, base plate 138, front base shroud 142, extrusion assembly 146, and an external door assembly 150. The advertising display unit 40 also has screen braces 154 and 158 and corresponding screen clamps 162 and 166 respectively.

The base plate 138 is designed to attach to a floor at a position where the digital display 40 is to be located. The base plate 138 is bolted to the floor. The base plate 138 includes openings 170 and 173 for passage of power cables from underneath the floor upwardly through the base plate 138 and into the digital display 40. The base shroud 134 and front base shroud 142 surround the base plate 138 to prevent access to the base plate 138 and cables.

Screen braces 154 and 158 are spot welded to the main body 130. A main body assembly 130 includes screen brasses 154 and 158. The main body assembly also includes the extrusion assembly 146 which is riveted to the main body 130. The main body assembly attaches to the base plate 138 via a sub frame (not shown) which attaches the main body assembly, base shroud 134, front base shroud 142 and base plate 138 together.

The advertising display unit 40 also includes a floor shelf 140. The floor shelf 140 is designed to sit on top of an internal flange 141 of the main body 130. The floor shelf 140 is designed to support the modem 100 and processor 110. The floor shelf 140 ensures that the modem 100 and processor 110 are supported above the floor to which the advertising display unit is attached. This ensures that the modem 100 and processor 110 do not sit in fluid that may pass under the digital display 40 such as spilled drinks and the like.

The screen 120 is fitted into the screen braces 154 and 158 and attached to the main body 130 using the screen clamps 162 and 166. The external door assembly 150 is attached to the main body 130 via the extrusion assembly 146.

The advertising display unit 40 also includes a lock which locks the door assembly 150 relative to the main body 130. The lock includes a lock bracket 170 which is attached to the external door assembly 150 and a corresponding cam lock 172 which is attached to the main body 130.

The brace 154 is also designed for attachment of the modem 100 and aerial 124.

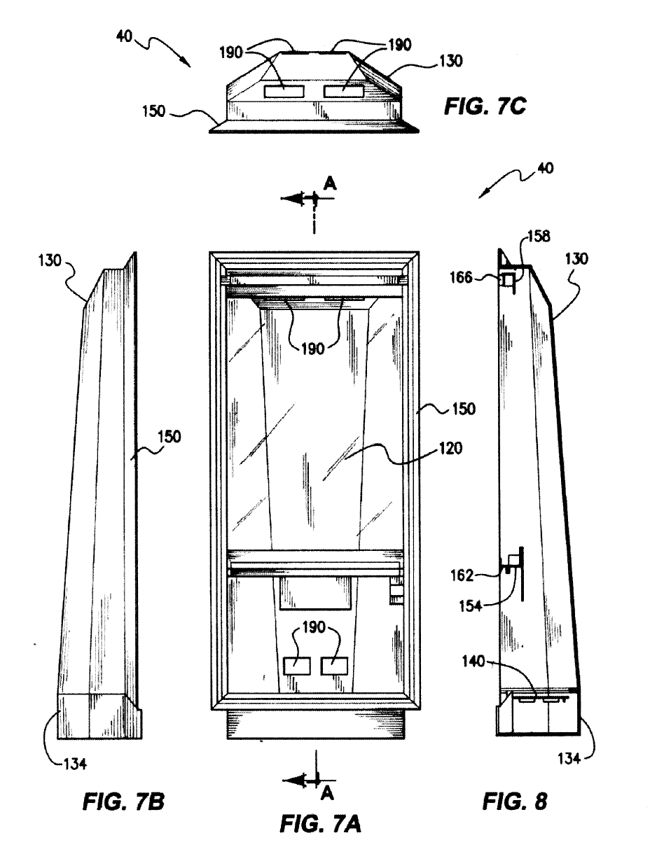

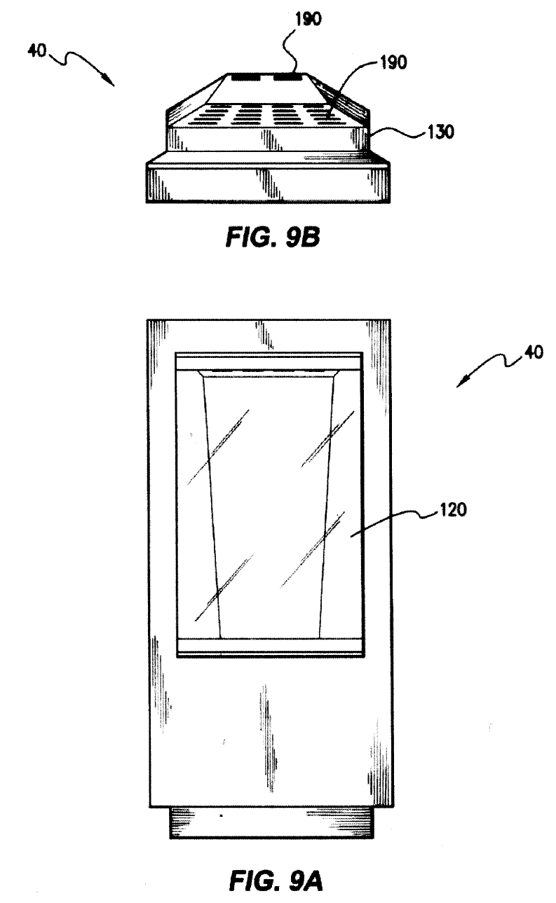

The main body 130 includes ventilation slots 190 which are schematically indicated in FIGS. 7, 7c and 9b.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. For instance, the present invention may also be applied to systems where the long rage wireless data network is replaced with an internet connection to a wireless LAN which is located proximate to the advertising display units.

1. A method for causing a new advertising image to be displayed on a plurality of advertising display units, said plurality of advertising display units being accessible to a content distribution system through a long range wireless data network, said method comprising the steps of transmitting data representing said new advertising image from said content distribution system to said plurality of advertising display units using said long range wireless data network, whereby said data is made available to each of said plurality of advertising display units for display of the new advertising image; and subsequently displaying said new advertising image at said plurality of advertising display units; wherein said data is of sufficiently small size such that said data is received at each of said plurality of advertising display units shortly after transmission.

2. A method according to claim 1 wherein said long range wireless data network is a publicly available mobile telephone network.

3. A method according to claim 1 wherein the new advertising image is high definition.

4. A method according to claim 3 wherein the size of the file comprising the data is less than 5 Mb.

5. A method according to claim 4 wherein the data representing the image is in a vector-based image format.

6. A method according to claim 1 wherein said plurality of advertising display units is distributed over a wide geographic area so that a proportion of said plurality of advertising display units is located at least two separate public spaces.
